(19) United States
(12) Patent Application Publication
(10) Pub. No.: US 2018/0239419 A1
(43) Pub. Date: Aug. 23, 2018

(54) WIRELESS TRANSCEIVER SYSTEM USING BEAM TRACKING

(71) Applicant: WiseJet, Inc., Daejeon (KR)

(72) Inventors: Inn Yeal OH, Daejeon (KR); Byeong Nam AHN, Yongin-si (KR); Chul Soon PARK, Daejeon (KR)

(73) Assignee: WiseJet, Inc., Daejeon (KR)

(21) Appl. No.: 15/685,327

(22) Filed: Aug. 24, 2017

(30) Foreign Application Priority Data
Feb. 21, 2017 (KR) 10-2017-0023066

(51) Int. Cl. G06F 3/01; H04B 10/69

(52) U.S. Cl. CPC G06F 3/012; H01Q 3/2611; H04B 10/697

(57) ABSTRACT

Disclosed is a wireless transceiver system including an image transmitting apparatus and an image receiving apparatus. The image receiving apparatus includes a receiving antenna having a head direction set for each received beam and a control unit that measures one or more of received signal strength, bit error rate, and signal to noise ratio for each received beam and tracks a receiving beam direction so as to track the received beam and create head tracking information.

### BACKGROUND OF THE INVENTION

### 1. Field of the Invention

The present invention relates to a wireless transceiver system using beam tracking and, more specifically, to a wireless transceiver system including an image receiving apparatus that tracks a receiving beam to create head tracking information and an image transmitting apparatus that creates a control image to which head tracking is applied.

### 2. Description of Related Art

In the conventional art, a head tracking information is generated through an acceleration sensor, an angular velocity sensor, or a gyro sensor of a HMD (Head Mounted Display) device or a motion tracking information is generated through an infrared camera.

In Korean patent publication No. 2016-0013906, a method of generating the head tracking information through the acceleration sensor, the angular velocity sensor, or the gyro sensor of the HMD device is disclosed. In Korean patent registration No. 1288590, a method of generating the motion tracking information through the infrared camera is disclosed.

However, in the conventional art, since the reaction velocity of the sensor is slow, it can be longer than a latency required by the HMD device. Also, since the image generation is delayed, there is a problem in that the user may become dizzy. For example, in the conventional are, where the angular velocity sensor or the gyro sensor are operated in the frequency of 200 Hz, since the reaction velocity is 5 m/sec, it may be longer than the latency required by the HMD device.

### SUMMARY OF THE INVENTION

An object of the present invention is to provide a wireless transceiver system including an image receiving apparatus that tracks a receiving beam to create head tracking information and an image transmitting apparatus that creates a control image to which head tracking is applied.

According to an aspect of the invention to achieve the object described above, there is a provided a wireless transceiver system using beam tracking including an image transmitting apparatus that transmits an image to an image receiving apparatus; and the image receiving apparatus that moves depending on the movement of a user, wherein the image receiving apparatus includes a receiving antenna having a head direction set for each received beam and a control unit that measures one or more of received signal strength, bit error rate, and signal to noise ratio for each received beam and tracks a receiving beam direction so as to track the received beam and create head tracking information.

Preferably, the control unit includes a beam tracking unit that measures one or more of the received signal strength, the bit error rate, and the signal to noise ratio for each received beam and tracks a receiving beam direction; a beam setting unit that sets a receiving beam direction in which the maximum received signal strength, the minimum bit error rate, or the maximum signal to noise ratio is obtained; and a motion analyzing unit that analyzes a rotation angle between a previously formed receiving beam direction as a reference and a predetermined receiving beam direction and creates head tracking information.

Preferably, the motion analyzing unit that analyzes the received signal strength between the previously formed receiving beam direction as a reference and the predetermined receiving beam direction and creates motion tracking information including a direction, a distance, and a position of the movement of a user.

Preferably, the receiving antenna performs receiving beam forming in the predetermined receiving beam direction.

Preferably, the image transmitting apparatus that processes the image with a control image, to which head tracking is applied, by using the head tracking information.

Preferably, the image transmitting apparatus includes an array of transmitting antennas, tracks a transmitted beam for each beam direction of the transmitting antennas, and sets the transmitting beam direction, and the transmitting antennas performs beam forming in the predetermined transmitting beam direction.

Preferably, the image transmitting apparatus creates motion tracking information with reference to the received signal strength of the receiving antenna corresponding to a previously formed transmitting beam direction and the predetermined transmitting beam direction.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a wireless transceiver system using beam tracking according to an example of the present invention;

FIG. 2 is a block diagram illustrating the image receiving apparatus in FIG. 1 in detail;

FIG. 3 is a block diagram illustrating the control unit in FIG. 2 in detail;

FIG. 4 shows an example illustrating an operating method of the wireless transceiver system in FIG. 1;

FIG. 5 shows an example illustrating a method of performing the head tracking in the image receiving apparatus in FIG. 4;

FIG. 6 shows another example illustrating an operating method of the wireless transceiver system in FIG. 1;

FIG. 7 shows an example illustrating a method of tracking a head in the image receiving apparatus in FIG. 6;

FIG. 8 shows an example illustrating a method of tracking motion in the image receiving apparatus in FIG. 6;

FIG. 9 is a block diagram illustrating a wireless transceiver system using beam tracking according to another example of the present invention;

FIG. 10 shows an example illustrating an operating method of the wireless transceiver system in FIG. 9; and

FIG. 11 shows an example illustrating a method of tracking motion in the image transmitting apparatus in FIG. 10.

### DETAILED DESCRIPTION OF THE PREFERRED EMBODIMENTS

Hereinafter, preferred embodiments of the invention will be described in more detail with reference to the accompanying drawings.

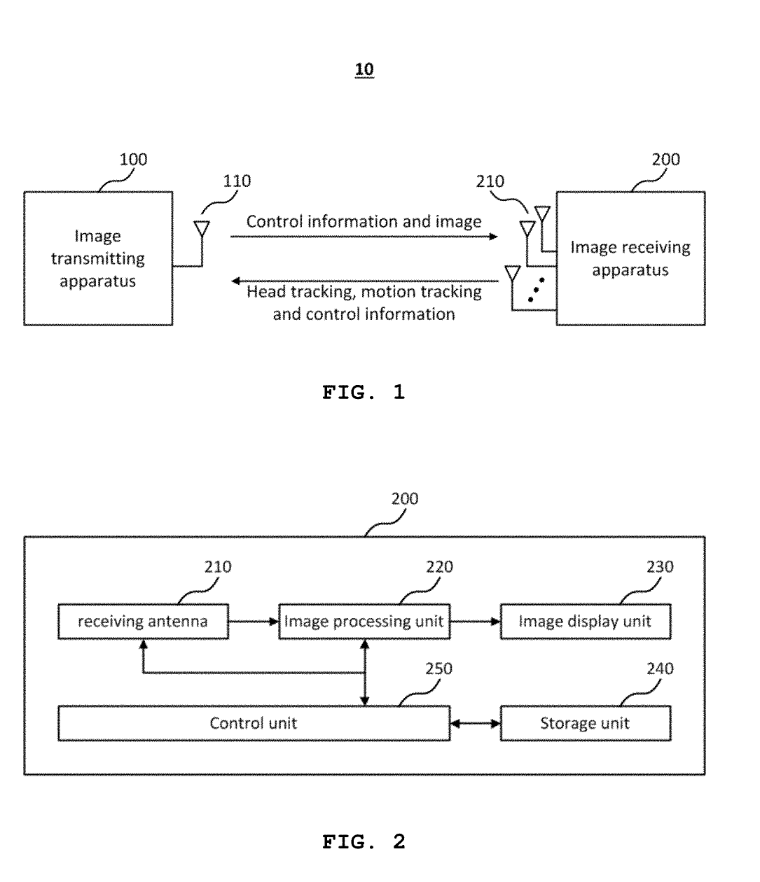

FIG. 1 is a block diagram illustrating a wireless transceiver system using beam tracking according to an example of the present invention. A wireless transceiver system 10 includes an image transmitting apparatus 100 and an image receiving apparatus 200. The image transmitting apparatus 100 transmits an image to the image receiving apparatus 200 in real time, and the image receiving apparatus 200 plays the received image.

As illustrated in FIG. 1, the image transmitting apparatus 100 may include a transmitting antenna 110 configured of a single antenna, and the image receiving apparatus 200 may include an array of receiving antennas 210.

The image transmitting apparatus 100 may be a portable smartphone or a stationary desktop PC or console. The image receiving apparatus 200 is a portable HMD apparatus. On the other hand, the image receiving apparatus 200 may operate at a fixed position, and the image transmitting apparatus 100 may operate at a position that changes depending on the movement of a user.

The image transmitting apparatus 100 and the image receiving apparatus 200 are capable of transmitting and receiving control information, and the image transmitting apparatus 100 is capable of transmitting an image to the image receiving apparatus 200 at real time. The control information may include one or more items of input event information input by a user, image control information, and communication control information.

The input event information may be information input through an input device (not illustrated) of the image transmitting apparatus 100 or the image receiving apparatus 200, the image control information may be clock information or interface information of an image, and the communication control information may be information for controlling bidirectional transmission. The input device may be installed in the image transmitting apparatus 100 or the image receiving apparatus 200, and the input device may be one of a touch pad, a stylus pen, a wireless pen, a button key, a virtual key, a wired mouse, a wireless mouse, and a joystick.

The image transmitting apparatus 100 may include a HID input device that inputs input event information, may control a view angle direction of an image in response to the input event information, and may transmit, to the image receiving apparatus 200, an image to which the input event information is applied.

The image receiving apparatus 200 may include a HMD input device that inputs input event information, may control a view angle direction of an image in response to the input event information, and may apply the input event information to an image and perform processing of the image.

According to the present invention, since it is possible to directly process the input event information input from the image receiving apparatus 200 without transmitting the information to the image transmitting apparatus 100, it is possible to disperse the operation complexity of the image transmitting apparatus 100, and it is possible to increase the operation efficiency of the image receiving apparatus 200.

FIG. 2 is a block diagram illustrating the image receiving apparatus in FIG. 1 in detail, and the image receiving apparatus 200 moves depending on the movement of a user.

The image receiving apparatus 200 includes receiving antennas 210, an image processing unit 220, an image display unit 230, and a control unit 250.

The receiving antennas 210 receive an image from the image transmitting apparatus 100, the image processing unit 220 processes the image transmitted from the image transmitting apparatus 100, and the image display unit 230 plays the processed image. The image processing unit 220 is capable of processing an image in accordance with an image playback format with reference to the image control information including the clock information or the interface information of an image.

According to the present invention, it is possible to transmit and receive an image regardless of output port interface standards of the image transmitting apparatus 100.

The receiving antennas 210 are provided in an array thereof, are capable of steering a beam, and are also capable of having a function of transmission. For example, the receiving antennas 210 are capable of transmitting various items of information such as control information, head tracking information, or motion tracking information to the image transmitting apparatus 100.

Radio waves in a millimeter waveband have path loss and straightness due to a short wavelength. The receiving antennas 210 may include a beamformer that performs directional beam forming because wireless channels of millimeter waves or longer are in a condition of non-line of sight (NLOS) due to movement and an image may be disconnected.

The beamformer is capable of operating based on analog beam forming (ABF) or digital beam forming (DBF).

A beamformer based on the analog beam forming adjusts a shape and a direction of a beam by using a difference in amplitude and phase of a signal and may include a phase shifter, an attenuator, a low-noise amplifier, and a frequency down-converter.

A beamformer based on the digital beam forming processes a signal by applying a weight vector to a digitized signal and may include a low-noise amplifier, a frequency down-converter, an AD converter, and a digital signal processor.

The receiving antennas 210 may have an array structure of multiple beams at predetermined angular intervals in the horizontal direction, the vertical direction, or the horizontal direction and the vertical direction, and a head direction is set or mapped for each received beam.

The control unit 250 measures one or more of the received signal strength (RSSI), the bit error rate (BER), and the signal to noise ratio (SNR) for each received beam and tracks a receiving beam direction.

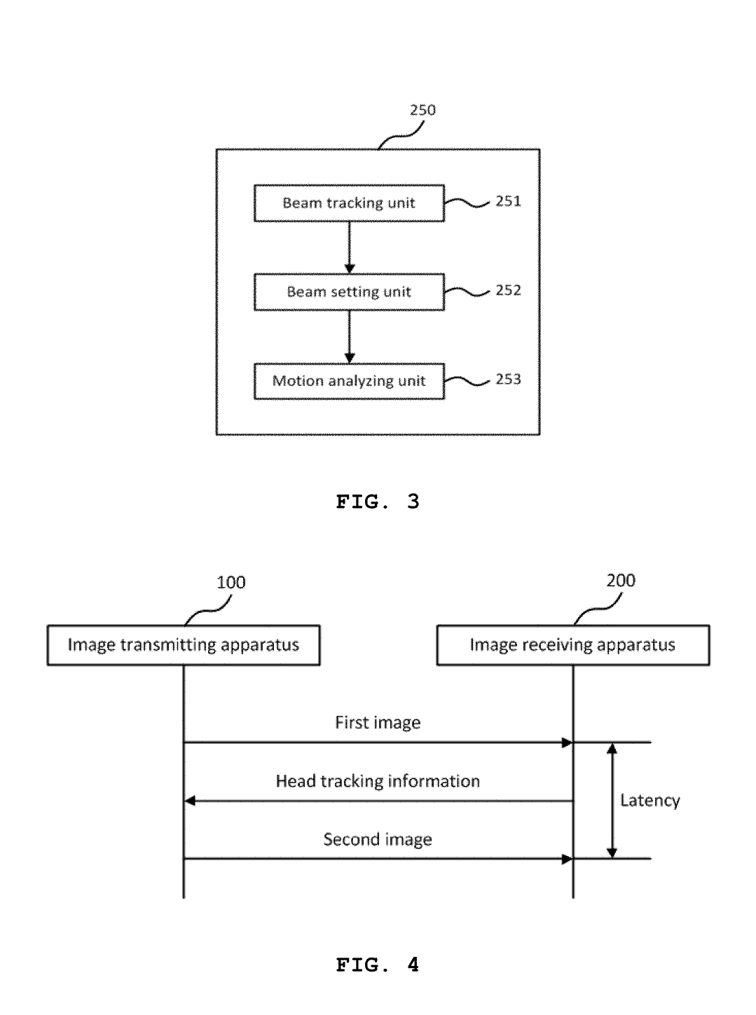

FIG. 3 is a block diagram illustrating the control unit in FIG. 2 in detail, and the control unit 250 includes a beam tracking unit 251, a beam setting unit 252, and a motion analyzing unit 253.

The beam tracking unit 251 measures one or more of the received signal strength, the bit error rate, and the signal to noise ratio for each received beam and tracks a receiving beam direction.

The beam tracking unit 251 is capable of measuring the received signal strength by calculating the intensity of a signal received from the receiving antennas 210 and is capable of measuring the bit error rate or the signal to noise ratio by demodulating the received signal into a baseband signal. The image processing unit 220 is capable of calculating the bit error rate or the signal to noise ratio by demodulating the received signal.

The beam setting unit 252 sets a receiving beam direction in which the maximum received signal strength, the minimum bit error rate, or the maximum signal to noise ratio is obtained.

The motion analyzing unit 253 analyzes a rotation angle between a previously formed receiving beam direction as a reference and a predetermined receiving beam direction and creates head tracking information.

The motion analyzing unit 253 has a head direction set for each received beam of the receiving antennas 210 and is capable of analyzing a rotation angle of a currently receiving beam direction with a previously formed receiving beam direction as a reference. When the receiving antennas 210 include multiple beams at predetermined angular intervals in the horizontal direction, the motion analyzing unit 253 is capable of creating head tracking information configured of two-dimensional coordinates including x-axis and y-axis coordinates. When the receiving antennas 210 include multiple beams at predetermined angular intervals in the horizontal direction and the vertical direction, the motion analyzing unit 253 is capable of creating head tracking information configured of three-dimensional coordinates including x-axis, y-axis, and z-axis coordinates. In addition, the motion analyzing unit 253 is capable of converting the three-dimensional coordinates into the two-dimensional coordinates.

The head tracking information may include two-dimensional or three-dimensional information and may include rotation angle information.

When the beam setting unit 252 sets a receiving beam direction, the receiving antennas 210 may perform receiving beam forming in the predetermined receiving beam direction.

The image receiving apparatus 200 may further include a storage unit 240 that updates the predetermined receiving beam direction to a currently receiving beam direction and stores the received-beam information, and the motion analyzing unit 253 may analyze subsequent user movement with the received-beam information as a reference.

FIG. 4 shows an example illustrating an operating method of the wireless transceiver system in FIG. 1, and the image transmitting apparatus 100 transmits a first image to the image receiving apparatus 200. The image transmitting apparatus 100 is capable of transmitting not only the first image but also control information to the image receiving apparatus 200.

The image receiving apparatus 200 measures one or more of the received signal strength, the bit error rate, and the signal to noise ratio for each received beam and tracks the received beam, and sets a receiving beam direction in which the maximum received signal strength, the minimum bit error rate, or the maximum signal to noise ratio is obtained. When the receiving beam direction is set, the image receiving apparatus 200 may perform receiving beam forming in the predetermined receiving beam direction.

The image receiving apparatus 200 analyzes a rotation angle between the previously formed receiving beam direction and the predetermined receiving beam direction and creates head tracking information.

FIG. 5 shows an example illustrating a method of performing the head tracking in the image receiving apparatus in FIG. 4. The receiving antennas 210 may have 12 beams at 30-degree intervals in the horizontal direction, and a head direction may be set for each of the 12 received beams. According to the present invention, the receiving antennas 210 may have multiple beams at predetermined angular intervals in the vertical direction, and the number of beams is not limited.

When a previously formed receiving beam is the first beam, and a currently set receiving beam is the tenth beam, the image receiving apparatus 200 is capable of analyzing that the head rotates to the right and analyzing that the rotation angle is 45 degrees. The image receiving apparatus 200 transmits the head tracking information to the image transmitting apparatus 100, and the image transmitting apparatus 100 creates a control image having an image angle of view changed by 45 degrees to the right.

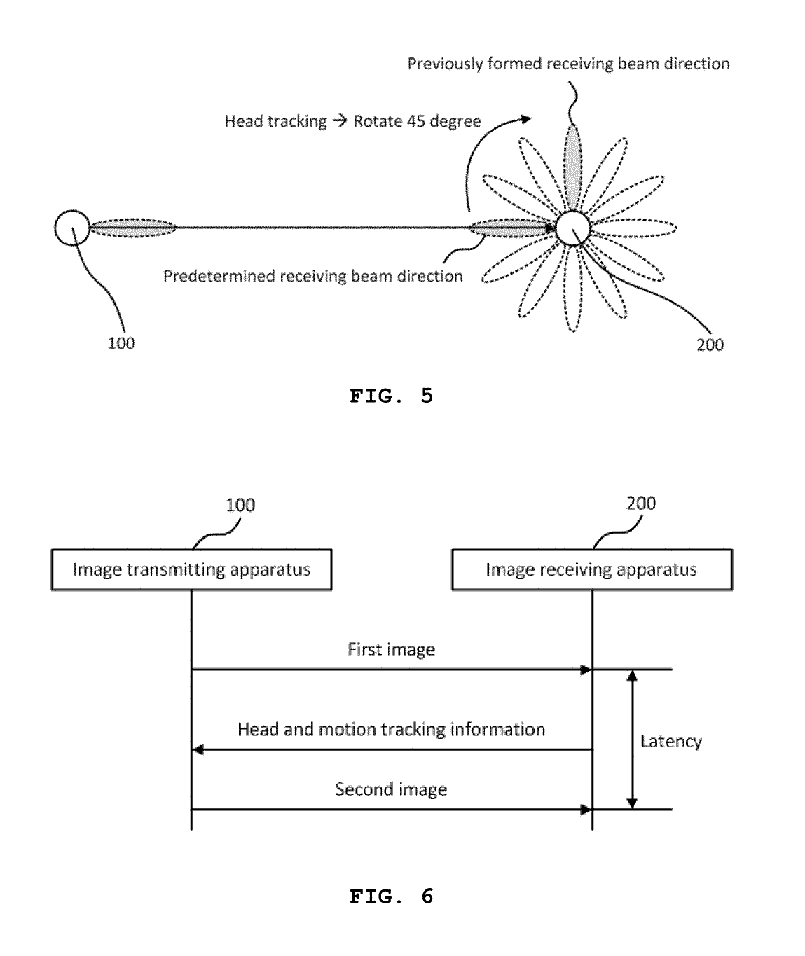

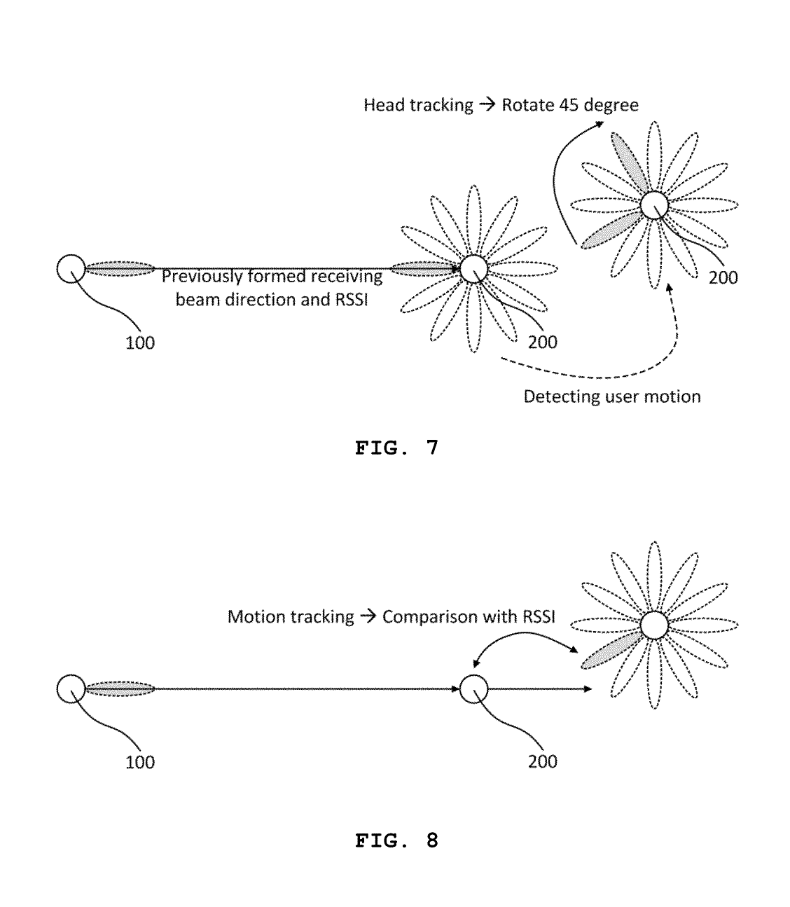

FIG. 6 shows another example illustrating an operating method of the wireless transceiver system in FIG. 1, FIG. 7 shows an example illustrating a method of tracking a head in the image receiving apparatus in FIG. 6, and FIG. 8 shows an example illustrating a method of tracking motion in the image receiving apparatus in FIG. 6. The image receiving apparatus 200 is capable of creating not only the head tracking information but also motion tracking information.

The motion analyzing unit 253 analyzes the received signal strength between the previously formed receiving beam direction as a reference and the predetermined receiving beam direction and creates motion tracking information including a direction, a distance, and a position of the movement of a user.

When movement occurs by a user, the motion analyzing unit 253 is capable of analyzing the received signal strength between the previously formed first beam and the currently set tenth beam and is capable of creating the motion tracking information including a direction, a distance, and a position of the movement of a user. The motion tracking information may be created as a coordinate form.

The image receiving apparatus 200 simultaneously performs head tracking or motion tracking while performing beam forming by tracking a beam, thereby making it possible to create a high-definition image without delay by providing a rate that is suitable for the line-of-sight communication and request latency.

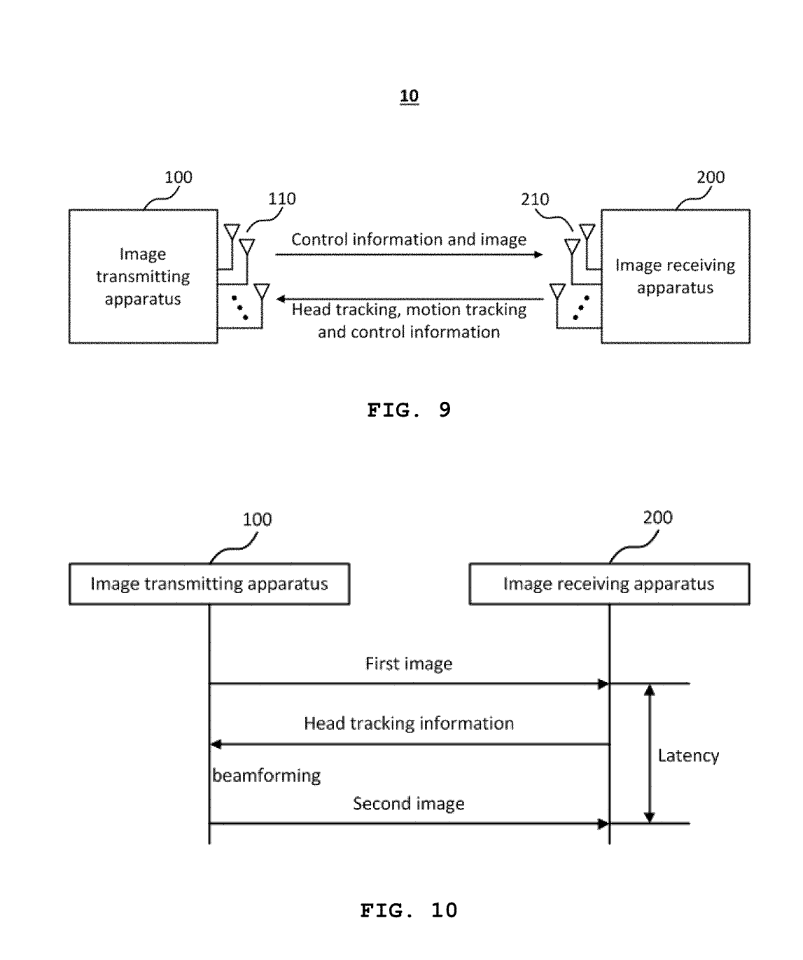

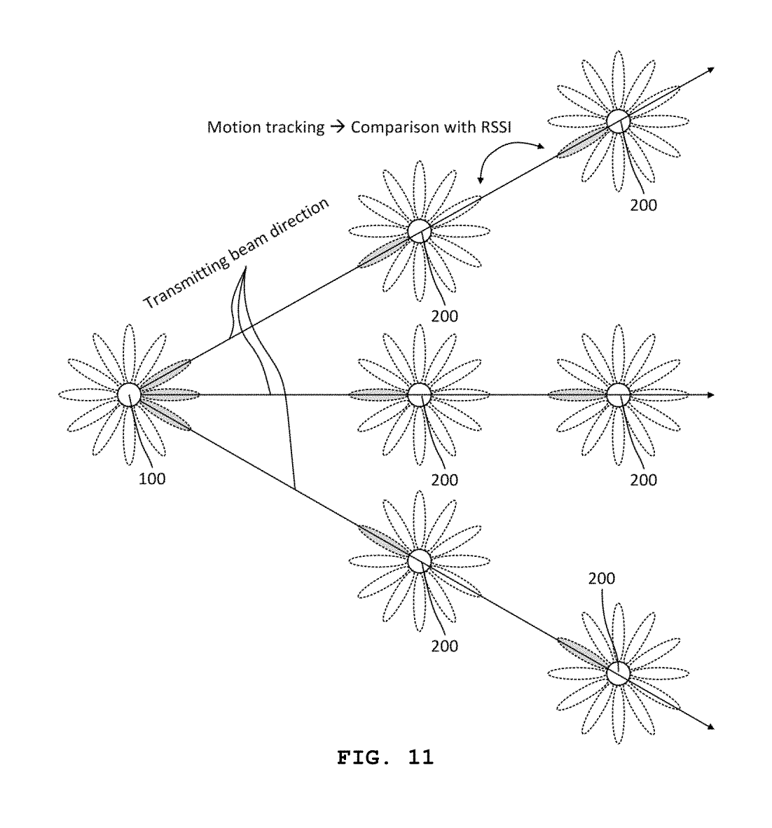

FIG. 9 is a block diagram illustrating a wireless transceiver system using beam tracking according to another example of the present invention, FIG. 10 shows an example illustrating an operating method of the wireless transceiver system in FIG. 9, and FIG. 11 shows an example illustrating a method of tracking motion in the image transmitting apparatus in FIG. 10.

The image transmitting apparatus 100 may include an array of transmitting antennas 110 or may set the transmitting beam direction and perform motion tracking of the image receiving apparatus 200.

The image transmitting apparatus 100 may track a transmitted beam for each beam direction of the transmitting antennas 110, and set the transmitting beam direction, and the transmitting antennas 110 may perform beam forming in the predetermined transmitting beam direction.

The image transmitting apparatus 100 may create motion tracking information with reference to the received signal strength of the receiving antennas 210 corresponding to a previously formed transmitting beam direction and the predetermined transmitting beam direction.

The image transmitting apparatus 100 may create motion tracking information by tracking a transmitted beam for each beam direction of the transmitting antenna 110 and creates a control image to which the motion tracking is applied.

The image transmitting apparatus 100 simultaneously performs motion tracking while performing beam forming by tracking a beam, thereby making it possible to create a high-definition image without delay by providing a rate that is suitable for the line-of-sight communication and request latency.

According to the present invention, the transmitting and receiving beams are arranged by setting beam directions such that wireless channels of millimeter waves or longer are maintained in a condition of line of sight, thus, it is possible to avoid image disconnection. Also, it is possible to improve the efficiency of the system by using the system in conjunction with an operation of head tracking or motion tracking while beam direction setting is used for beam arrangement.

According to the present invention, the head tracking and the motion tracking can be performed by tracking the beam, so that it does not require separate multiple sensors including at least any one among the acceleration sensor, the angular velocity sensor, the gyro sensor, and the infrared camera and can reduce the cost of the multiple sensors. Also, since the control images can be transmitted and received in a shorter time than the required latency, it can remove the cause of the user's dizziness and the user can enjoy the video in that the head tracking or the motion tracking is applied.

According to the present invention, by tracking the beam, the head tracking or the motion tracking can be performed at the same time while performing the Beam-forming, so that it can provide a speed for line of sight communication and required latency, thereby implementing a zero-delay transmitting and receiving technique of high quality image.

While the present invention has been described with respect to the specific embodiments, it will be apparent to those skilled in the art that various changes and modifications may be made without departing from the spirit and scope of the invention as defined in the following claims.

What is claimed is:

1. A wireless transceiver system using beam tracking comprising:
an image transmitting apparatus that transmits an image to an image receiving apparatus; and
the image receiving apparatus that moves depending on the movement of a user,
wherein the image receiving apparatus comprises a receiving antenna having a head direction set for each received beam and a control unit that measures one or more of received signal strength, bit error rate, and signal to noise ratio for each received beam, and tracks a receiving beam direction so as to generate head tracking information.

2. The wireless transceiver system as claimed in claim 1, wherein the control unit comprises:
a beam tracking unit that measures one or more of the received signal strength, the bit error rate, and the signal to noise ratio for each received beam and tracks a receiving beam direction;
a beam setting unit that sets a receiving beam direction in which the maximum received signal strength, the minimum bit error rate, or the maximum signal to noise ratio is obtained; and
a motion analyzing unit that analyzes a rotation angle between a previously formed receiving beam direction as a reference and a predetermined receiving beam direction and creates head tracking information.

3. The wireless transceiver system as claimed in claim 2, wherein the motion analyzing unit that analyzes the received signal strength between the previously formed receiving beam direction as a reference and the predetermined receiving beam direction and creates motion tracking information including a direction, a distance, and a position of the movement of a user.

4. The wireless transceiver system as claimed in claim 2, wherein the receiving antenna performs receiving beam forming in the predetermined receiving beam direction.

5. The wireless transceiver system as claimed in claim 1, wherein the image transmitting apparatus processes the image with a control image, to which head tracking is applied, by using the head tracking information.

6. The wireless transceiver system as claimed in claim 1, wherein the image transmitting apparatus includes an array of transmitting antennas, tracks a transmitted beam for each beam direction of the transmitting antennas, and sets the transmitting beam direction, and the transmitting antennas performs beam forming in the predetermined transmitting beam direction.

7. The wireless transceiver system as claimed in claim 6, wherein the image transmitting apparatus creates motion tracking information with reference to the received signal strength of the receiving antenna corresponding to a previously formed transmitting beam direction and the predetermined transmitting beam direction.
